(19) United States
(12) Patent Application Publication
(10) Pub. No.: US 2015/0344822 A1
(43) Pub. Date: Dec. 3, 2015

(54) Decontaminant and Process for Decontamination of Chemicals from Infrastructural Materials

(71) Applicant: Tetra Tech, Inc., Pasadena, CA (US)

(72) Inventor: Sandip Chattopadhyay, Cincinnati, OH (US)

(21) Appl. No.: 14/728,477

(22) Filed: Jun. 2, 2015

Related U.S. Application Data
(60) Provisional application No. 62/006,464, filed on Jun. 2, 2014.

(51) Int. Cl. C11D 3/04; C11D 3/43

(52) U.S. Cl. CPC C11D 3/046; C11D 3/43; C11D 3/042

(57) ABSTRACT

A decontaminant and method for decontaminating an infrastructural system is disclosed, the decontaminant including from about 3% to about 5%, by weight, of a permanganate compound; from about 8% to about 12%, by weight, of a strong mineral acid; and from about 80% to about 90%, by weight, of a solvent.

### FIELD

This disclosure relates to the field of decontamination methods and decontaminant compositions. More particularly, this disclosure relates to a method and composition for decontaminating chemicals from solid surfaces and infrastructural materials.

### BACKGROUND

When contaminants are released into an infrastructural system (e.g., a utility fluid distribution system), the contaminants may adhere to a surface of the system, thereby making it difficult to substantially remove such contaminants from the system. A primary concern is terrorism or other intentional or unintentional acts of man resulting in a contamination of an infrastructural system (e.g., a municipal water system). In such a scenario, some of the contaminants would remain within the system even after treatment, such as by adhering to interior surfaces within the system. A complete shutdown and thorough piece by piece decontamination of the infrastructure of such a system may be necessary to remove the contaminants from the interior surfaces of structures so that any residual contaminants do not pose a serious health or problem to the consuming population or the environment. Replacement of infrastructural materials is expensive due to installation of new materials and disposal of hazardous materials. As such, appropriate decontamination of such a system in situ would bring significant cost savings.

While various treatments exist for eliminating contaminants within a utility distribution system, multiple types of treatments may be required for the removal of various individual contaminants. Further, very little information is available regarding which particular flushing treatments are effective at removing specific contaminants in such a system.

What is needed, therefore, is a decontaminant treatment composition and method that is effective for removing a variety of contaminants from an infrastructural system (e.g., a municipal water supply system).

### SUMMARY

A decontaminant composition is disclosed, the composition comprising from about 3% to about 5%, by weight, of a permanganate compound; from about 8% to about 12%, by weight, of a strong mineral acid; and from about 80% to about 90%, by weight, of a solvent. In certain embodiments, the composition may include about 4%, by weight, of a permanganate compound. Preferably, the permanganate compound is sodium permanganate and potassium permanganate. In certain embodiments, the composition may include about 10%, by weight, of a strong mineral acid. In one embodiment, the strong mineral acid consists essentially of sulfuric acid. In another embodiment, the strong mineral acid includes perchloric acid, hydroiodic acid, hydrobromic acid, hydrochloric acid, sulfuric acid or combinations thereof.

The decontaminant composition may further comprise from about 0.5% to about 3%, by weight, of a persulfate compound or, in some embodiments, about 1%, by weight, of a persulfate compound. Preferably, the persulfate compound consists essentially of sodium persulfate. Alternatively or additionally, the decontaminant composition may further comprise from about 100 parts per million to about 10,000 parts per million of a surfactant. In one embodiment, the decontaminant composition comprises 0.8%, by weight, of surfactant. In one embodiment, the solvent consists essentially of water.

A decontaminant composition is disclosed comprising from about 0.5% to about 2%, by weight, of sodium persulfate; from about 100 parts per million to about 10,000 parts per million of a surfactant; from about 3% to about 5%, by weight, of a compound selected from the group consisting of sodium permanganate, potassium permanganate, or combinations thereof; from about 8% to about 12%, by weight, of a strong mineral acid selected from the group consisting of perchloric acid, hydroiodic acid, hydrobromic acid, hydrochloric acid, sulfuric acid and combinations thereof; and from about 80% to about 88%, by weight, of water.

A method of decontaminating an infrastructural system is disclosed, the method comprising the step of exposing a surface of the infrastructural system with a chemical compound comprising from about 3% to about 5%, by weight, of a permanganate compound; from about 8% to about 12%, by weight, of a strong mineral acid; and from about 80% to about 90%, by weight, of a solvent.

The exposing step may further comprise the step of exposing a surface of the infrastructural system with a chemical compound comprising from about 3% to about 5%, by weight, of a permanganate compound; from about 8% to about 12%, by weight, of a strong mineral acid; from about 100 parts per million to about 10,000 parts per million of a surfactant; and from about 80% to about 90%, by weight, of a solvent.

The exposing step may further comprise the step of exposing a surface of the infrastructural system with a chemical compound comprising from about 3% to about 5%, by weight, of a permanganate compound; from about 8% to about 12%, by weight, of a strong mineral acid; from about 0.5% to about 3%, by weight, of a persulfate compound; and from about 80% to about 90%, by weight, of a solvent.

The exposing step may further comprise the step of exposing a surface of the infrastructural system with a chemical compound comprising from about 0.5% to about 2%, by weight, of sodium persulfate; from about 100 parts per million to about 10,000 parts per million of a surfactant; from about 3% to about 5%, by weight, of a compound selected from the group consisting of sodium permanganate and potassium permanganate; from about 8% to about 12%, by weight, of a strong mineral acid selected from the group consisting of perchloric acid, hydroiodic acid, hydrobromic acid, hydrochloric acid, sulfuric acid and combinations thereof; and from about 80% to about 88%, by weight, of water.

The exposing step may further comprise the step of exposing a surface of the infrastructural system with a chemical compound comprising about 4%, by weight, of a permanganate compound; about 10%, by weight, of a strong mineral acid; from about 100 parts per million to about 10,000 parts per million of a surfactant; and from about 80% to about 86%, by weight, of a solvent.

The exposing step may further comprise the step of exposing a surface of the infrastructural system with a chemical compound comprising about 4%, by weight, of a permanganate compound; about 10%, by weight, of a strong mineral acid; about 1%, by weight, of a persulfate compound; and from about 80% to about 86%, by weight, of a solvent.

The exposing step may further comprise an action selected from the group consisting of pouring the chemical compound on a contaminated surface, wiping a contaminated surface with the chemical compound using a cloth-like material, immersing a contaminated infrastructural body inside a vessel containing the chemical compound, and recirculating the chemical compound inside a fluid transport body. A cloth-like material is broadly defined herein as any material having cloth-like characteristics including a cotton cloth, a paper towel or other similar material. A fluid transport body is broadly defined herein as any structure useful for transporting fluid from a first location to a second location. For example, a fluid transport body may include a pipe, a conduit, or a trough.

The summary provided herein is intended to provide examples of particular disclosed embodiments and is not intended to limit the scope of the invention disclosure in any way.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a cross-section deposit product distribution on a copper pipe;

FIG. 2A shows secondary electrons of a representative region of adhered mercury on copper pipe;

FIG. 2B shows backscattered electrons of a representative region of adhered mercury on a copper pipe;

FIG. 3 shows entrapment of contaminants in a porous surface of an infrastructural material inner wall; and

FIG. 4 shows a schematic diagram showing occlusion of contaminant particles within organic matter and other surfaces in an infrastructural system.

The figures are provided to illustrate concepts of the invention disclosure and are not intended to limit the scope of the invention disclosure to the exact embodiments provided in the figures.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

The present disclosure describes a chemical decontaminant and process for removing various contaminants from a solid substrate of an infrastructural system (e.g., a municipal water supply system). The chemical decontaminant includes a persulfate compound, a permanganate compound, a surfactant and a mineral acid compound. The chemical decontaminant of the present disclosure provides effective removal of various contaminants such as mercury and organophosphates that have been sorbed into inner surfaces of an infrastructural system, such as water pipes or building infrastructural materials such as tile, concrete and other porous or semi-porous materials.

The chemical decontaminant includes from about 3% to about 5%, by weight, of a permanganate compound. Preferably the chemical decontaminant of the present disclosure includes approximately 4%, by weight, of the permanganate compound. Examples of the permanganate compound include, for example, an alkali permanganate (e.g., potassium permanganate or sodium permanganate). The chemical decontaminant of the present disclosure includes from about 8% to about 12%, by weight, of a highly corrosive mineral acid. Mineral acids used may include perchloric acid, hydroiodic acid, hydrobromic acid, hydrochloric acid, and sulfuric acid. Preferably, the chemical decontaminant includes approximately 10%, by weight, of sulfuric acid.

The chemical decontaminant of the present disclosure may optionally include from about 0.5% to about 3%, by weight, of a persulfate compound. Preferably, the chemical decontaminant of the present disclosure optionally includes approximately 1%, by weight, of a persulfate compound such as, for example, an alkali persulfate such as sodium persulfate. The decontaminant may optionally include a surfactant. The concentration of surfactant can vary from about 0.01% to about 1% per weight/volume basis (e.g., from about 100 ppm to about 10,000 ppm in water). The surfactant may be non-ionic, cationic, anionic or zwitterionic. Preferably, the chemical decontaminant includes approximately 0.8%, by weight, of surfactant.

Finally, the chemical decontaminant of the present disclosure includes from about 80% to about 90%, by weight, of a solvent. Solvents that may be used include primarily water and potentially some substantially inert materials and trace compounds. The chemical decontaminant of the present disclosure has been found to be effective in removing various contaminants that have adhered to walls of infrastructural materials within an infrastructural system (e.g., a fluid distribution system). By introducing the chemical decontaminant of the present disclosure into the system, the contaminants are effectively removed from the walls of the infrastructural materials and carried by the chemical decontaminant out of the fluid distribution system without untoward residual effects on the fluid system.

The surface complexation of ions and ligands of contaminants occur on solid infrastructural surfaces. Dissolution-precipitation and sorption reactions of organics and metals, the chemistry of water, protonation of surface by acid catalyzed dissolution, and ligand promoted dissolution play important roles in decontamination of contaminants. The decontamination of infrastructural material and building surfaces occurs through a surface controlled dissolution reaction.

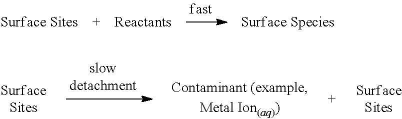

The sequence of the above interactions may consist of additional small interaction steps. The decontamination of contaminants involves following key considerations: a) the attachment/sorption of chemicals on the infrastructural surfaces is fast, b) the subsequent detachment/dissolution of the species from the infrastructural materials to the solution phase is slow and thus rate limiting, and c) the original surface sites are continually reconstituted. The dissolution reaction is initiated by the surface coordination with protons, hydroxyl anions, and ligands, which polarizes, weakens and tends to break the contaminant bonds in the lattice of the surface. Roll up or emulsification of contaminants from surfaces by surfactant may also occur. In case of mercury, it should be noted that the equilibria controlling the decontamination mechanism depends on various factors including the following: a) desorption of sorbed species, b) oxidation of mercury, c) complexation of mercury ions by competing complexing agents, and d) dissolution of precipitated mercury such as mercury oxides. The readsorption and recomplexation of the dissolved mercury species on infrastructural surfaces or organic matter (biofilm) on infrastructural surfaces may cause a shift in the mercury distribution and may lead to a lower decontamination efficiency. In addition to chemical mechanisms, transport mechanisms also control the decontamination process. Since chemical species can bound to infrastructural material that may be covered by another phase (for example, a coating of iron oxide or biofilm), diffusion limits the speed of decontamination process to a great extent. As some of the infrastructural materials are porous, the macro-, meso-, and micro-pores of these structural materials can provide significant surface area where the sorbed as well as complexed chemicals are located. Decontamination by mass transport can also be enhanced by increasing the turbulence of the decontaminant fluid, using brushing, stirring or scrubbing techniques.

### EXAMPLES

### I. Test Procedure Summary

Studies have been conducted in connection with the composition of the present disclosure. One such study was conducted involved two tasks:
1. Task 1—Laboratory testing to assess potential for surface adherence of selected contaminants;
2. Task 2—Laboratory testing to examine efficacy of decontamination agents.

Task 1 focused on conducting sorption studies to determine the level of adherence of contaminants to different materials as a function of exposure time and temperature. The chemical contaminants of interest for this effort were primarily limited to mercury, although other contaminants were studied that included organophosphate insecticides; rodenticide; fungicide; poisonous chemicals; drugs; and gasoline. Pipe materials included copper, polyvinyl chloride (PVC), high-density polyethylene (HDPE), aged black iron pipe (ACI), steel pipe coated with epoxy (DIE), cement lined ductile iron pipe with asphalt sealant (DIW), and cement lined ductile iron pipe without asphalt sealant (DIO).

Task 1 was conducted as three subtasks to vary test parameters of exposure time and temperature. Subtask 1A was performed to evaluate overall adherence of the chemical contaminants after exposure to a pipe for a period of seven days at 20-25° C. This subtask included nine chemical contaminants and seven pipe materials. For subtasks 1B and 1C, mercuric chloride was evaluated with respect to three types of building materials DIW, PVC and copper. Subtask 1B was conducted to evaluate overall adherence of the chemical contaminant for 24 hours at 20-25° C. Subtask 1C was performed to evaluate overall adherence of the chemical contaminants for seven days at 4-6° C.

Task 2 was designed to evaluate the potential efficacy of decontamination agents against contaminants such as mercury that exhibited adherence under Task 1. The pipe materials used for subtask 2 were DIE, DIW, PVC and copper. Various decontamination agents were used, and they were: commercially available sodium hypochlorite, Simple Green® brand decontaminant agent available from Sunshine Makers, Inc., Pipe-Klean® brand decontaminant agent available from HERC Products Incorporated, and the chemical decontaminant of the present disclosure. Types of interactions included scrubbing, flushing, recirculation, shaking and static equilibrium.

Results obtained showed cement-lined ductile iron pipes (with and without sealant) adhered most of the tested chemicals. Generally, low adherence was observed on PVC and HDPE.

Mercury was equilibrated with DIW, PVC, copper and DIE pipes for 7 days at 20 to 25° C. After equilibration, the contaminant was extracted using the various decontamination agents. The selected decontaminants were not effective in removing mevinphos from the pipe surfaces, but the new decontaminant disclosed herein was able to remove most of the adhered mevinphos from the various surfaces after three rinses. Though mercury adhered on DIW and copper pipes, the commercially available decontaminants (sodium hypochlorite, Simple Green®, and Pipe-Klean®) were not effective in releasing the adhered mercury. The chemical decontaminant of the present disclosure was effective in removing adhered mercury and other contaminants.

### II. Introduction

The removal of contaminants is dependent on various factors, including physical and chemical properties of a material surface (for example, hydrophobicity, roughness, and material of construction), characteristics of contaminants (for example, concentration, water solubility, volatility, persistence, and presence of co-contaminants) and the type of decontamination activities employed.

Decontamination of infrastructure is necessary to remove the contaminants from the interior surfaces and interior pores so that the residual contaminant does not pose health or aesthetic problems for an extended period of time after a release or disaster event. Decontamination of surfaces can be conducted by flushing with water (with or without detergents); using high pressure, high temperature steam; using oxidizing chemicals and caustic chemicals; and other methods. Lory et al. (2002) reported that no one treatment can remove all chemical or biological threat agents. Two factors, dilution by water and the residual chlorine, or other disinfectant in treated water, generally make it difficult to introduce an effective dose of most chemicals into a water distribution system. However, there are some chemicals (like mercury) that are resistant to high concentrations of chlorine or surfactant and, therefore, are impervious to treatment by chlorination and other conventional methods.

Table 1 provides an overview for the basic design of each task or subtask. The Task 1A was conducted using the above list of materials. A shorter list of materials was tested in the subsequent tasks. The shorter list was derived from the results of Task 1A based on the extent of adherence, stability of the chemical, solid substrate characteristics, and practicality.

TABLE 1
Task Matrix Overview¹

| | | Pipe Materials | |
|---|---|---|---|
| Task | Subtask | Tested | Test Variables |
| 1 | A | 7 pipe materials² - | 20-25° C., 7 days |
| | | PVC, HDPE, | |
| | | copper, ACI, DIE, | |
| | | DIW, and DIO | |
| | B | 3 pipe materials - | 20-25° C., 24 hours |
| | | DIW, PVC and | |
| | | copper | |
| | C | 3 pipe materials - | 4-6° C., 7 days |
| | | DIW, PVC and | |
| | | copper | |
| 2 | | 4 pipe materials - | 4 decontamination chemical |
| | | DIE, DIW, PVC | treatments³ |
| | | and copper | |

¹The tests conducted in duplicates
²The pipe materials abbreviations are: polyvinyl chloride (PVC), high density polyethylene (HDPE), aged black iron pipe (ACI), steel pipe coated with epoxy (DIE), cement lined ductile iron pipe with asphalt sealant (DIW), and cement lined ductile iron pipe without asphalt sealant (DIO).
³The adhesion tests, prior to the application of decontamination agents, were conducted at 20-25° C. for 7 days.

In the water distribution system, pipe wall provides ubiquitous sorptive surfaces. Sorption is a process by which a sorbate (mercury and/or other contaminants) can adhere, bind or redistribute from the aqueous phase to a surface (sorbent). This disclosure uses the term adherence to describe the property of holding, binding, attaching or joining of chemical agents in the presence of water on surfaces of various compositions. The adherence of chemical agents on solid surfaces depends on a number of factors including the following: a) available surface area; b) physical and chemical properties of surfaces including porosity, surface charge, hydrophobicity or hydrophilicity; c) water quality including factors such as temperature, pH, and salinity; d) physical and chemical properties of chemical agents such as solubility, stability in water, and chemical structure, and e) the presence of other contaminants such as, for example, organic materials or biofilms.

The commercially available decontaminants used in the study of the present disclosure included sodium hypochlorite, Simple Green®, Pipe-Klean®, and the chemical decontaminant of the present disclosure.

Sodium hypochlorite or bleach is a strong oxidizing agent and typically used for decontamination of microorganisms. Simple Green® is a commercially available product labeled as an all purpose cleaner and degreaser by Sunshine Makers, Inc. of Huntington Harbour, Calif. Pipe-Klean® is another commercially available product and claimed to be a rehabilitation solution used to chemically clean corrosion from pipes by HERC Products Inc. of Portsmouth, Va. The specific chemical ingredients of these proprietary chemicals Simple Green® and Pipe Klean® were not available. The approach taken in selecting concentrations was based on potential levels that are considered to be most suitable for use in a water distribution system. The level of free chlorine recommended in the American Water Works Association (AWWA) guidelines required at least 100 mg/L of free chlorine for a three hour exposure period (AWWA, 1999). In the case of a water main break, or as in our case, an intentional contamination event, the dose may be increased to 300 mg/L. For this task, a target concentration of 300 mg/L free chlorine was used to treat the pipes for a period of three hours. This concentration was lower than concentrations typically used for decontamination in a laboratory environment but more realistic for a water distribution system.

### III. Materials and Methods

The materials and methods for this study included preparation of stock solutions of the chemical agents, preparation of test water, adherence and decontaminations tests, quality assurance (QA) and quality control (QC) procedures, and development of adherence criteria. The following sections provide a general description of these elements.

### A. Chemical Contaminant

Tap water was used to prepare the aqueous solutions of the chemicals. A 6-L HDPE container was filled with hot tap water (48-50° C.) and left overnight to reach room temperature. The tap water was purged by nitrogen gas. The degassing by nitrogen was continued for at least 30 minutes for each set of experiments to reach total residual chlorine content in the water ≦0.3 mg/L. The free and total chlorine of the degassed tap water was taken using Hach DR/2000 Direct Reader Spectrophotometer in accordance with the instructions supplied with the instrument (Hach Method 8167). The instrument has a detection range from 0 to 2.00 mg/L. After degassing, the total chlorine was usually between 0.0 and 0.02 mg/L. The pH was measured using a Corning pH/ion meter model 450. The pH of the degassed tap water was 7.8. Measured amounts of mercury compound were added to the degassed tap water, and the mixtures were stirred for about 1-hour on an orbital shaker running at moderate speed to prepare the aqueous solutions. The final concentrations of mercury achieved in various tasks are shown in Table 3. The chemicals gravimetric measurements were conducted by using Mettler AE 163 balance. Calibration of instruments was performed before taking measurement. Though the input aqueous concentration of the chemical (amount of chemical per mL) in each material for a subtask remained the same, the amount of chemical and aqueous solution volume varied with each pipe type since the pipes had different volumes associated with them. For example, the volume for a PVC pipe was 100 mL and the volume for DIE was 150 mL.

The yearly average alkalinity and total organic carbon (TOC) concentrations in Public Supply tap water were 54 mg/L as CaCO₃ and 3.02 mg/L, respectively. The reported average turbidity of tap water was 0.07 nephelometric turbidity units (NTU), average pH value was 7.66, and the average residual free chlorine was 1.55 mg/L. One representative tap water sample was analyzed by commercial analytical laboratory, and the reported turbidity was 0.4 NTU, TOC was 2.0 mg/L, and alkalinity 39 mg/L. Alkalinity was measured by titration in accordance with U.S. EPA 310.1 Method 2320B for the examination of water and wastewater. TOC was measured in accordance with Method 5310C, known to persons having ordinary skill in the art.

TABLE 2
Mercury, Organophosphates and Their Physical And Chemical Properties

| | | Molecular | Chemical | | Aqueous | Hazardous | |
|---|---|---|---|---|---|---|---|
| Contaminant | Source | Weight | Group | Structure | Solubility | Ingredients | Remarks |
| Mercuric | Sigma- | 271.5 | Fungicides | Cl—H [symbol] —Cl | 69-74 | Oral (rat) | May be light |
| chloride | Aldrich | | | | g/L at | LD₅₀ | sensitive. |
| | (215465- | | | | 20° C. | 1 mg/kg | Incompatible with |
| | 100G), | | | | | | strong bases, |
| | Lot # | | | | | | carbonates, |
| | 13727KB, | | | | | | sulfides, cyanides, |
| | ACS | | | | | | alkalis, sulfites, |
| | reagent | | | | | | sulfates, hydrogen |
| | 99.5% | | | | | | peroxide, |
| | | | | | | | ammonia, iodine, |
| | | | | | | | hydrogen |
| | | | | | | | bromide. |
| Mevinphos | Suppelco (PS-87), Lot # LB323- 57A, 97.4% mix of isomers | 224.15 | Organo- phosphate insecticide | 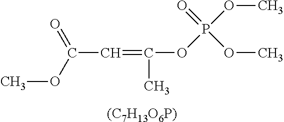 | Highly soluble | LD50 oral (rat) 3.7-6.1 mg/kg | Also known as phosdrin. |
| Dichlorvos | Suppelco (PS-89), Lot # LB325- 21B, 98% | 220.98 | Organo- phosphate insecticide | 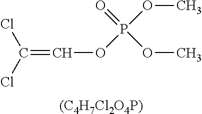 | 10 g/L | LD50 oral (rat) 56 to 80 mg/kg | In water, dichlorvos degrades primarily by hydrolysis, with a half-life of approximately 4 days in lakes and rivers (Half-life varies from 20 to 80 hours between pH 4 and pH 9. Hydrolysis is slow at pH 4 and rapid at pH 9). |
| Dicrotophos | Suppelco (PS-602), Lot # LB328- 101B, 99% | 237.19 | Organo- phosphate insecticide | 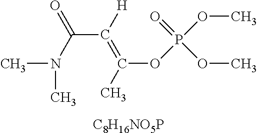 | 1.0 g/L water | Oral LD50 for rats is 16- 21 mg/kg. | Dicrotophos is stable when stored in glass or polythene containers up to 40° C., but is decomposed after 31 days at 75° C. or 7 days at 90° C. The half-lives of dicrotophos in pH 5, 7, and 9 buffer solutions are 117, 72, and 28 days, respectively. |

[symbol]

indicates data missing or illegible when filed

TABLE 3
Initial Concentrations of Representative Chemicals Used in Various Tasks

| Task | Chemical | Concentration (mg/L) |
|---|---|---|
| Task 1A | Mercury | 22829.8 |
| Task 1B | Mercury^{a} | 8171.5 |
| | Mercury^{a} | 23950.0 |
| Task 1C | Mercury^{b} | 7737.5 |
| | Mercury^{b} | 28800.0 |
| Task 2 | Mercury | 19530.0 |
| Task 1A | Mevinphos | 1591.6 |
| | Dichlorvous | 2035.5 |
| | Dicrotophos | 230.3 |
| | Mercury | 22829.8 |
| Task 1B | Mevinphos | 1607.9 |
| | Mercury² | 8171.5 |
| | Mercury² | 23950.0 |
| Task 1C | Mevinphos | 1538.2 |
| | Mercury^{(b)} | 7737.5 |
| | Mercury^{(b)} | 28800.0 |
| Task 2 | Mevinphos | 1283.1 |
| | Mercury | 19530.0 |

^{a}The unit of this concentration range is mL gasoline/L. About 10-mL of gasoline was added to each of the pipes, which had varying volumes of water.
^{b}Two concentrations of mercury were used to understand the effect of concentration on surface adherence.

### B. Pipe Materials and Batch Test Containers

Various types of infrastructural materials were purchased from different suppliers, and all description, source, and pipe segment dimensions are shown in Table 4. The pipes received from the suppliers were cut using a hand saw and a miter box, or a fine tooth power saw with suitable guides to obtain the pipe segments as shown in Table 4. The size of the pipe segments were selected considering the smallest diameter available, practicality of laboratory handling, and maximizing a surface area to volume ratio. Any burrs on the pipe edges, generated due to the cutting process, were removed with a knife, file, and abrasive paper. Care was taken so that pipe surfaces remained clean and free of oil and other foreign materials. The pipes segments were soaked in tap water for approximately 30-minutes to allow the cement lining to adsorb some water before the chemical solution was added. Other pipes were flushed voluminously with tap water to remove residual organic contaminants from manufacturing processes to imitate water transport systems currently in use and minimize analysis interferences.

Each test container consisted of a pipe segment made of the materials listed in Table 4. To prevent any loss due to adherence of chemicals to the end caps, one end of the pipes was first wrapped with a double layer of a nonstick coating film (i.e., Teflon® brand nonstick film available from E. I. du Pont de Nemours and Company or its affiliates). Teflon® brand nonstick coating provides a low energy surface, and so adhesive interfacial contact with test liquid (wettability) is expected to be very limited. Each layer of Teflon® brand nonstick coating layer was secured to the outside surface of the pipe using translucent tape. An appropriate diameter vinyl round cap (see Table 4) for the respective pipe was then placed over the covered end. A 4½″ stainless steel screw clamp was fastened for the large diameter pipes (3″ cement lined ductile iron pipe with/without asphalt sealant) to secure the cap. A 14″ cable tie was also wound around the cap, in addition to the clamp in order to provide extra security. A 7″ cable tie was utilized for the smaller diameter pipes (PVC, HDPE, and Copper).

TABLE 4
Description of Test Material, Supplier, and Dimensions

| Description (Supplier) | |
|---|---|
| Abbreviation | Dimensions, inch (cm)^{(a)} |
| 2″ Aged Black Iron Pipe Schedule 40 (Steven Steel Supply, | I.D. = 2.12 (5.38) |
| Columbus, Ohio) ACI | O.D. = 2.38 (6.03) |
| | L = 3.00 (7.62) |
| 1″ Copper Type M^{(b)} (Westwater Supply Corporation, Columbus, | I.D. = 1.06 (2.70) |
| Ohio) Copper | O.D. = 1.12 (2.86) |
| | L = 8.06 (20.48) |
| 1″ High density poly ethylene (HDPE) (Westwater Supply Corp., | I.D. = 1.02 (2.60) |
| Columbus, Ohio) HDPE | O.D. = 1.21 (3.07) |
| | L = 8.00 (20.32) |
| 1″ Poly vinyl chloride Schedule 40 (Westwater Supply | I.D. = 1.04 (2.65) |
| Corporation, Columbus, Ohio) PVC | O.D. = 1.32 (3.36) |
| | L = 8.00 (20.32) |
| 3″ Cement lined Ductile iron pipe DIP53 without seal (Ferguson | I.D. = 2.75 (6.98) |
| Waterworks, Columbus, Ohio) DIO | O.D. = 4.00 (10.16) |
| | L = 3.06 (7.78) |
| 3″ Cement lined Ductile iron pipe CL53 TYTON JT with seal | I.D. = 2.71 (6.88) |
| (Ferguson Waterworks, Columbus, Ohio) DIW | O.D. = 3.87(9.84) |
| | L = 3.00 (7.62) |
| 2″ Steel pipe coated with high solids epoxy (Martin Painting & | I.D. = 2.06 (5.24) |
| Coating Co., Grove City, Ohio) DIE | O.D. = 2.37 (6.03) |
| | L = 3.06 (7.78) |
| Vinyl round caps (Niagara Caps & Plugs, Erie, Pennsylvania) | 1″ diameter and below: ¾″ |
| | lengths |
| | 1″ diameter and above: 1½″ |
| | lengths |
| | Wall thickness: 0.040-0.065 ± |
| | 0.010 depending on size |
| Stainless steel hose clamp (Home Depot, Ohio) | Diameter = 4.5 inch (10.16 cm) |

^{(a)}I.D. = average inside diameter; O.D. = average outside diameter; L = average length.
^{(b)}Type M is thinner and is used on municipal water supplies that carry treated water that is supposed to be gentler on pipes (Jim Rooney, Feb. 5, 2005, The Capital, Annapolis, MD).

### C. Test Procedure

The aqueous solution filled pipes were allowed to equilibrate at room temperature (20-25° C.) for 7 days for task 1A and 24 hours for task 1B. Testing for task 1C was conducted by keeping the aqueous solution filled pipes in a Norlake Scientific controlled temperature chamber—stability room (4-6° C.). After equilibration, the pipes were shaken by hand for about 20-30 seconds and then carefully opened by piercing the Teflon® brand nonstick layer cover with a disposable sterile glass pipettes to avoid contamination. The solution from the pipe was transferred to labeled sample vials containing appropriate preservative. All excess solution from the pipes was disposed appropriately. The type of analytical sample container and preservatives used for mercury chloride were 100 mL HDPE and hydrochloric acid (HCl), respectively.

In Task 1, the pipes were rinsed immediately after the equilibrated solution was transferred into the analytical sample vials. Thereafter, de-ionized water at room temperature was used for rinsing the pipes. Three consecutive rinses were conducted using de-ionized water at room temperature. Rinse solution was collected into the appropriate sample container, as indicated in Table 5. In case of aged black iron pipe, the aqueous solution was centrifuged before transferring to the sample vials to avoid entrainment of colloidal corroded iron particles in the solution. During the extraction step, the pipes were about half filled with the extraction solution and wrapped tightly. The 4″ diameter pipes were filled with 150 mL of extraction solution. The copper, PVC, and HDPE pipes were filled with 55 mL of extraction solution, while the epoxy and the aged metal pipes were filled with 85 mL of extraction solution. After the extraction solutions were added to the pipes, they were placed on a Lab-Line Orbit brand shaker (Lab-Line Instruments, Inc., Melrose Park, Ill., model 3590) oscillating at 100 rpm for 2 hours. After shaking for 1 hour, the pipes were flipped in order to get contact with the entire inner surface of the pipe. The extraction solutions were transferred to the appropriate sample vial.

### D. Decontaminants

A decontamination process has been referred to a method employed to destroy, reduce, or remove a contaminant to an acceptable level. Mechanical cleaning methods such as pigging, scraping, reaming and honing have been used to remove blockages from water distribution systems. These methods, however, require extensive excavation and opening of the distribution system for insertion of the appropriate mechanical tools (Ludwig and Shenkiryk, 2002). Valves must usually be removed and replaced along with hydrants, while elbows and hydrant connects are not usually cleaned mechanically. Fire protection systems such as fire sprinkler systems are virtually impossible to clean mechanically. Corrosion causes small pits in the walls of fluid distribution systems which cannot also be completely cleaned by mechanical methods. In addition, residual bacterial growth results in new tuberculation with resulting reduced flow as well as increased biological contamination. In this study, water soluble chemical decontaminants were tested to remove or neutralize adhered contaminants from the pipe segments. Water distribution systems can be cleaned by a low cost process using decontaminant solutions that are circulated in isolated sections of the system.

### Physical Decontaminants

Water was used to physically remove contaminants from surfaces, and water with detergents was found to be effective as a decontamination agent. Decontamination by surfactant or detergents in water occurs predominantly by the physical removal or dilution of the agent. The intent of a surfactant is not to detoxify the chemical but to solubilize it into a solution that can detoxify it. The use of surfactant and water for the physical removal of contaminants from a surface can also limit the spread of contamination. There are four categories of surfactants currently in use: anionic surfactants, cationic surfactants, zwitterionic and nonionic surfactants. Anionic surfactants are generally more powerful in terms of solubilizing the contaminants into an aqueous solution, than cationic or nonionic surfactants. It has also been seen that surfactant—water and hot water also have the capability to neutralize chemicals to some extent by the chemical method of slow hydrolysis. However, hydrolysis is limited due to the typically low solubility and slow rate of diffusion of agents in water.

### Chemical Decontaminants

Most of the current decontaminants used in the detoxification of contaminants can be considered reactive chemicals. Reactive chemicals are ones that readily react with another chemical without the need for stirring, heating, or shaking. In general, oxidizing agents, strong bases, and microemulsions may be used as chemical decontaminants.

Sodium hypochlorite (NaOCl), which is a powerful oxidizing agent, has been used effectively in this study for the detoxification of chemicals. When NaOCl dissolves in water, it results in a solution that contains hypochlorite ions, which is the actual decontamination agent for a number of CB agents. Sodium hypochlorite (NaOCl) solution was purchased from Sigma-Aldrich, Inc. (CAS 7681-52-9, batch #14914PB), and contains about 10-15% available chlorine. Household bleach is a 3-6% concentration of sodium hypochlorite. Physical and chemical properties of NaOCl are shown in Table 5.

TABLE 5
Physical and Chemical Properties of Sodium Hypochlorite

| | |
|---|---|
| Formula Weight | 74.44 |
| Boiling Point | 111° C. |
| Specific Gravity | 1.25 |
| Permissible Exposure | 0.5 mg/L (v) |
| Limit | |
| Availability | Manufactured only in solution form. Industrial |
| | grade sodium hypochlorite contains 10-15% |
| | (weight) NaOCl (10-17.8% available chlorine) |
| | with about 0.50% to 1.00% excess NaOH for |
| | stability control. |
| Flash Point | >94° C. |
| Appearance/Odor | Pale yellow solution with a characteristic odor |
| | due to breakdown products such as chlorine |
| pH | ~13 |
| Solubility in water | Soluble in all proportions |

Microemulsions are thermodynamically stable mixtures of water, oil, surfactants, and other chemicals that appear macroscopically as a homogeneous phase. Various water-soluble decontaminants can be dissolved into a microemulsion leading to a chemical system containing very small organic droplets dispersed into water (for an oil in water microemulsion) containing the decontaminant. When a chemical agent encounters a microemulsion system, it is partially dissolved (partitioned) into the organic phase of the microemulsion. Once dissolved, the agent can react with the water-soluble decontaminant at the surface of the organic portion of the microemulsion. The rate of agent decontamination is related to the size of the microemulsion particles. The smaller the particles are in a microemulsion, the faster the decontamination process. This is due to the high surface area of the reaction surface with respect to the amount of chemical agent dissolved, and the short diffusion paths from the center of the microemulsion particle to its surface.

As indicated earlier, one of the decontamination agents used was Pipe Klean® brand decontaminant, which is available from the HERC Products Inc., Portsmouth, Va. as a pipe rehabilitation solution for their technologies to clean water systems and surfaces. Pipe Klean® brand decontaminant is reported to be a low pH, aqueous organic biocleaner with dispersants and inhibitors that has been certified to ANSI/NSF Standard 60 for the use in potable water systems and applications (Shenkiryk, 2005). Physical and chemical properties of Pipe Klean® brand decontaminant are shown below in Table 6.

TABLE 6
Physical and Chemical Properties of Pipe Klean ®

| Boiling Point | 100° C. | | |
|---|---|---|---|
| Specific Gravity | 1.17-1.18 | | |
| Flash Point | >94° C. | | |
| Appearance/Odor | Light amber liquid/Mild burnt sugar | | |
| pH | 3.5 ± 0.5 | | |
| Percent volatile | 43% (volume) | | |
| Solubility in water | Complete | | |
| Hazardous Ingredients | Amount wt. % | PEL | TLV |
| Proprietary Composition | 58.1 | 3 mg/L | 3 mg/L |
| of which | 3.5 | | |
| Inert Ingredients | 42.0 | | |

Another decontamination agent selected was Crystal Simple Green® brand (Sunshine Makers, Inc., Huntington Harbour, Calif.), which is a commercially available specialized cleaner and degreaser for use in the industrial and institutional workplace. This cleaner was purchased from a local hardware store (Home Depot) and is referred to herein as Simple Green®. Physical and chemical properties of Simple Green® are shown in Table 7.

TABLE 7
Physical and Chemical Properties of Simple Green ®

| Type of surfactant | Non-ionic | | |
|---|---|---|---|
| Boiling Point | 100.6° C. | | |
| Specific Gravity | 1.02 | | |
| Appearance | Clear liquid | | |
| Hazardous Ingredients | Amount wt. % | PEL | TLV |
| Butyl cellosolve | <6% | 25 mg/L | 25 mg/L |

| | |
|---|---|
| pH | 9.35 (concentrate compound) |
| Solubility in water | Completely Soluble |

Ultrasonic cleaning and testing of Simple Green® was conducted by Sunshine Makers, Inc, Switzerland, who provided surface tension data for seven concentrations of Simple Green®. The available surface tension data was plotted against various concentration of Simple Green® in tap water available at Sunshine Makers, Inc., Switzerland, at 25° C.

The concentrations of the above three decontaminants selected for this study were: 1% (by volume) Pipe Klean®, 300 mg/L sodium hypochlorite, and 15% (by volume) Simple Green®. The chlorine concentration was selected based on the AWWA guidance on procedures for emergency disinfection of mains (Yoo, 1986). Surfactant molecules have both hydrophilic and hydrophobic parts, and the most attractive place for them in water is at the surface where the forces of both attraction and repulsion to water can be satisfied. The Simple Green® concentration was selected near the critical micellar concentration. The aqueous solutions of these decontaminants were prepared using the available chemical decontaminants and diluting them to required concentration by adding DI water. Appropriate volume corrections were conducted for NaOCl considering available solution concentration of NaOCl received from the supplier.

### E. Analytical Protocols Followed for Chemicals

Aqueous solutions of mercury were analyzed by Inductively Coupled Plasma Mass Spectrometer (ICP-MS) following procedures based on SW 846 Method 200.8. The sample was introduced via a peristaltic pump by pneumatic nebulization into radio frequency plasma where energy transfer processes cause desolvation, atomization, and ionization. The ions were extracted from the plasma through a pumped vacuum interface and separated on the basis of their mass-to-charge ratio by a quadrupole mass spectrometer. The ions transmitted through the quadrupole were registered by a continuous dynode electron multiplier and the ion information was processed by a data handling system.

Pipes equilibrated with aqueous solution of mercury at room temperature (20-25° C.) were studied spectroscopically to understand the interaction of these two sets of chemical and pipe combinations. The copper and cement lined ductile iron pipes were cut open to prepare samples for x-ray diffraction (XRD) analysis and scanning electron microscopy (SEM). The vibration from the band saw cut loosened a fair bit of the corrosion material adhering to the interior of the pipe. This material was collected and fragments from the pipe and cutting process were removed. The sample materials were lightly ground in an agate mortar and pestle. A portion of the ground sample was placed in the 0.5 mm recess of a Rigaku glass holder. The slide was then x-rayed on a Rigaku wide angle powder diffractometer running Materials Data, Inc. (MDI) automation and software (JADE 7+). The sample was scanned from 5 to 75 degrees two-theta, using a 0.024 step size and a speed of 0.3 degrees/minute. The x-ray radiation source used was a copper normal focus x-ray tube operated at 40 kV and 30 mA. The goniometer slit choices were the standard 1.0 degree diverging slit (DS) and scattered slit (SS), 0.15 mm receiving slit (RS) and a 0.6 mm slit in front of the scintillation counter. Further, a curved graphite monochromator was employed to remove the copper K-beta lines and much of the x-ray background from the pattern.

The raw data (collected) pattern was processed by first modeling and then removing the background inherent in the x-ray trace as well as the Kae line contributions. The derived pattern was then run through the extensive Search/Match programming module with accessibility to approximately 356,000 crystalline (inorganic and organic) indexed substances (Powder Diffraction File-2 Release 2004 and the Inorganic Crystal Structure Database/NIST version 2004-1). All sub files, without employing a chemistry filter, were evaluated to match the crystal structure of the unknown material to any pattern(s) in the database. Computer identification was then followed up with manual processing and identification to obtain the list of phases thought to be present in the supplied sample.

The interior surface of the cut pipes were also examined under a binocular microscope. Several different phases were seen. The cut surface was then imaged optically. The cut pipe sample was then carbon coated to examine in the JEOL 840A SEM. An accelerating voltage of 15 kV was used, and both secondary and backscattered electron images at several magnifications were collected.

### IV. Chemical Adhesion Estimation

Chemical adhesion onto a solid surface is usually due to the adsorption of the chemical on the surface of a solid, absorption of the chemical into the structure of a solid, precipitation of the chemical as a 3-dimensional molecular structure on the surface of the solid, or partition of the chemical into the organic matter (Sposito, 1989). Adsorption is the attachment of a solute to the surface of a solid phase, or, more generally, the accumulation of solutes in the vicinity of a solid-liquid interface, whereas absorption is the uptake of (dissolved) chemicals by a phase. Adsorption can be subdivided into physical adsorption (or physisorption), where the attraction to the surface is due to relatively weak forces such as the van der Waals force; electrostatic adsorption, where ions in solution are attracted by a surface of the opposite electrical charge (coulombic forces); and chemical adsorption (or chemisorption), where there is chemical bonding (ionic and/or covalent bonding) between the solute molecule and one or more atoms on the surface of the solid. The term of sorption, which is a generic term devoid of mechanism, is sometimes used to describe the partitioning of aqueous phase constituents to a solid pipe surface.

The objective of this section is to calculate a coefficient for adhesion for various chemicals tested with different pipe materials. The purpose of this coefficient is to enable comparisons of adherence of chemical contaminants on pipe materials. In this document the term “adhesion coefficient” (K_{ad}) will be used. This K_{ad} can be calculated as the concentration of a test chemical in one phase divided by the concentration of the same chemical in another phase. The concentration distribution is expected to be dependent on temperature, pressure, composition and other properties of the water system.

As the amount of chemical sorbed on the infrastructural materials is dependent on the wetted surface area, the K_{ad} can also be defined as the ratio of the amount of chemical sorbed per unit wetted surface area and the initial concentration of chemical in the water phase.

$${K}_{ad} = \frac{{C}_{s}}{{C}_{w}} = \frac{( {m}_{0} - {m}_{i} ) / {A}_{w}}{{C}_{w}}$$

where
K_{ad}=adhesion coefficient (L/m²).
Cₛ=Concentration of test chemical in pipe at equilibrium (mg/m²)
C_{w}=Concentration of test chemical in aqueous phase (mg/L)
m₀=initial amount of chemical in water input to the pipe segment (mg)=C_{w,o}×V₀, where C₀ is the initial concentration of chemical (mg/L) and V₀ is the initial volume of aqueous solution added to the pipe (L)
mᵢ=final amount of chemical present in the water after interacting with pipe material (mg)=Cᵢ×Vᵢ, where Cᵢ is the final concentration of chemical (mg/L) and Vᵢ is the final volume of aqueous solution present in the pipe (L)
A_{w}=wetted surface area (m²)

### V. Quality Objectives and Criteria

Dose and matrix controls were prepared to establish the stability and recovery of the chemicals from the test water. These data allowed for determination of accuracy and precision of the test method. In addition, the matrix controls were used to determine the baseline concentration of the chemical after the reaction/incubation period. For all tasks, test material controls that contained only test water were checked to determine the effect of the pipe on the water. It was important to establish whether there was a change in the water when reacted/incubated in the pipe material that would affect the recovery.

### E. Mercury

The ICP-MS was tuned, optimized, and calibrated daily with a minimum of five standards and a correlation coefficient greater than 0.998. Three mercury isotopes were monitored, with the data generated from the most abundant mass (AMU 202) were reported. Internal standards were used to correct for instrument drift and physical interferences. They were introduced in line via the peristaltic pump and analyzed with all blanks, standards and samples. If the absolute response of the internal standard deviated more than 40-125% of the original response, the samples were diluted and reanalyzed. Gold was added to all standards and samples to minimize analyte carry over. The calibration was verified with a Continuing Calibration Verification Standard (CCV). The CCV was analyzed immediately after the calibration standards, after every 10 samples, and at the end of the analytical run. The analytically determined value of the CCV was expected to agree within 10% of its known value or the instrument was recalibrated and the samples reanalyzed. All samples were serial diluted between 10× and 1,000,000× in order to bring the concentration of total mercury within the calibration curve. Most concentrations were confirmed using 2 separate dilutions. A minimum of one sample per dilution per analytical batch was spiked at a concentration of 10 parts per billion (ppb). The percent recovery of the analyte in the matrix spike was between 75% and 125%. The relative percent difference of the duplicate samples was less than 20%.

### VII. Results and Discussion

### A. Assessment of Potential for Surface Adherence of Mercury

TABLE 8
Concentration and Adherence of
Mercury on Various Materials in 7-Days at 20-25° C.

| | Ave. | |
|---|---|---|
| | Adhesion | |
| Contaminants | Coefficient | St. |
| and Pipes | (L/m²) | Dev. |
| DIW | 3.18 | 1.07 |
| DIO | 7.73 | 1.33 |
| ACI | 13.16 | 0.16 |
| PVC | NA | |
| HDPE | 0.03 | 0.05 |
| DIE | 11.92 | 0.05 |
| Copper | 6.61 | 0.06 |

NA = not adhered

TABLE 9
Concentration and Adherence of
Chemicals on Various Materials in 24 Hours at 20-25° C.

| | Ave. | |
|---|---|---|
| | Adhesion | |
| Contaminants | Coefficient | St. |
| and Pipes | (L/m²) | Dev. |
| Mercury¹ | | |
| DIW | 7.47 | 2.05 |
| PVC | 0.39 | 0.08 |
| Copper | 6.61 | 0.05 |
| Mercury² | | |
| DIW | 5.41 | 0.70 |
| PVC | NA | |
| Copper | 4.15 | 0.34 |

¹and²Two concentrations of mercury were used to study impact of concentration.
C_{w,0} = Initial concentration of chemical added to the pipe.
m₀ = initial amount of chemical in water input to the pipe.
mᵢ = final amount of chemical in water after interacting with ppe.
A_{w} = wetted surface area.

TABLE 10
Concentration and Adherence of
Mercury on Various Materials in 7-Days at 4-6° C.

| | Ave. | |
|---|---|---|
| | Adhesion | |
| Contaminants | Coefficient | St. |
| and Pipes | (L/m²) | Dev. |
| Mercury¹ | | |
| DIW | 16.30 | 1.15 |
| PVC | NA | |
| Copper | 6.58 | 0.07 |
| Mercury² | | |
| DIW | 5.62 | 1.10 |
| PVC | NA | 0.51 |
| Copper | 5.45 | 0.15 |

¹and²Two concentrations of mercury were used to study impact of concentration.
C_{w,0} = Initial concentration of chemical added to the pipe.
m₀ = initial amount of chemical in water input to the pipe.
mᵢ = final amount of chemical in water after interacting with pipe.
A_{w} = wetted surface area. NA = not adhered.

The difference between the amounts of chemical added and left after equilibration was used to calculate the amount of chemical adhered to the pipe surface. Average adhesion coefficients are also listed in Tables 8 through 10. The pipe inner-walls have different types of surface properties. Pipe degradation (such as, corrosion), scale deposits, by-product release have been observed for some samples from cast iron, cement-lined ductile iron.

A ranking of the adherence of selected chemicals in aqueous solutions on various pipe segments have been conducted based on the average concentration of chemicals in pipe at equilibrium (mg/m²). Table 11 provides the ranking of mercury on a particular material.

TABLE 11
Ranking Based on Adherence of a
Particular Chemical on Various Surfaces

| Contaminant | Pipe |
|---|---|
| Mercury | ACI > DIW > DIO > Copper > HDPE > PVC = DIE |

Ranking was conducted based on the adherence (mg/m²) of various chemicals on the pipe surfaces.

### B. Removal of Adhered Chemicals by Rinsing and Extractant

The aqueous concentrations of the chemicals at the beginning of the reaction with pipe (initial concentration, C_{w,0}), and the concentrations of the chemicals in the aqueous phase after reaction with pipe (final concentration, Cᵢ) are listed in Table 12. In this table, m₀ and mᵢ are the initial and final amounts of chemical in water. Tables 13, 14 and 15 present the concentrations of chemicals recovered from first, second, and third rinses and the extractants.

TABLE 12
Concentration and Adherence of
Mercury in Various Materials in 7-Days, 20-25° C.

| | Ave. Adhesion | |
|---|---|---|
| | Coefficient | |
| Contaminants and Pipes | (L/m²) | St. Dev. |
| Before Application of Chlorine (300 mg/L) | | |
| DIW | 13.89 | 1.90 |
| PVC | NA | |
| Copper | 6.77 | 0.02 |
| DIE | NA | 0.17 |
| Before Application of Simple Green (15%) | | |
| DIW | 13.49 | 3.43 |
| PVC | NA | |
| Copper | 6.72 | 0.07 |
| DIE | NA | |
| Before Application of Pipe-Klean ™ (1%) | | |
| DIW | 10.41 | 4.20 |
| PVC | NA | |
| Copper | 6.76 | 0.04 |
| DIE | NA | |

NA: not adhered

TABLE 13
Aqueous Concentrations of Mercury in Various Steps^{(a)}

| | | Conc. | | | | |
|---|---|---|---|---|---|---|
| | Initial | after | Rinsate | Rinsate | Rinsate | Extrac- |
| | Conc. | 7-day | #1 | #2 | #3 | tant |
| Material | (mg/L) | (mg/L) | (mg/L) | (mg/L) | (mg/L) | (mg/L) |
| DIW | 22829.8 | 17498.1 | 141.6 | 17.1 | 6.0 | 3610.8 |
| | 22829.8 | 20156.7 | 99.6 | 61.7 | 10.5 | 1264.8 |
| DIO | 22829.8 | 13836.1 | 110.3 | 9.5 | 5.0 | 9532.2 |
| | 22829.8 | 11619.6 | 117.0 | 25.9 | 12.5 | 7156.1 |
| ACI | 22829.8 | 3.5 | 1.8 | 26.2 | 98.6 | 3478.7 |
| | 22829.8 | 8.2 | 9.5 | 63.0 | 60.3 | 629.5 |
| PVC | 22829.8 | 22995.3 | 90.0 | 1.3 | 0.5 | 22.5 |
| | 22829.8 | 22763.5 | 178.1 | 34.4 | 20.6 | 139.2 |
| HDPE | 22829.8 | 22610.1 | 92.8 | 1.4 | 0.4 | 0.3 |
| | 22829.8 | 22845.6 | 121.7 | 4.7 | 3.0 | 0.5 |
| DIE | 22829.8 | 2171.4 | 86.9 | 3.5 | 2.1 | 187.6 |
| | 22829.8 | 2189.3 | 72.5 | 2.3 | 1.2 | 179.1 |
| Copper | 22829.8 | 41.4 | 2.7 | 1.0 | 6.8 | 7368.1 |
| | 22829.8 | 41.6 | 1.2 | 1.3 | 1.1 | 6413.5 |

^{(a)}Interactions with the aqueous solution of contaminants and pipe segments were conducted for 7 days at 20-25° C.
ND: non-detect.

TABLE 14
Aqueous Concentrations of Chemicals in Various Steps^{(b)}

| | | | | | | |
|---|---|---|---|---|---|---|
| | | Conc. | | | | |
| | Initial | after | Rinsate | Rinsate | Rinsate | Extrac- |
| | Conc. | 24 hrs | #1 | #2 | #3 | tant |
| Material | (mg/L) | (mg/L) | (mg/L) | (mg/L) | (mg/L) | (mg/L) |

Mercury #1

| | | | | | | |
|---|---|---|---|---|---|---|
| DIW | 8171.5 | 2874.2 | 23.4 | 0.7 | 130.5 | 914.1 |
| | 8171.5 | 5218.0 | 89.5 | 1.1 | 0.8 | 684.6 |
| PVC | 8171.5 | 7758.0 | 42.2 | 0.6 | 0.2 | 0.5 |
| | 8171.5 | 7627.0 | 96.3 | 1.3 | 0.1 | 0.2 |
| Copper | 8171.5 | 1.5 | 0.4 | 0.3 | 0.3 | 702.4 |
| | 8171.5 | 1.7 | 0.4 | 0.8 | 0.4 | 559.3 |

Mercury #2

| | | | | | | |
|---|---|---|---|---|---|---|
| DIW | 23950.0 | 15100.0 | 676.0 | 82.4 | 14.8 | 4950.0 |
| | 23950.0 | 17900.0 | 268.0 | 24.9 | 42.1 | 2360.0 |
| PVC | 23950.0 | 24800.0 | 82.2 | 1.0 | 0.3 | 0.3 |
| | 23950.0 | 23100.0 | 89.6 | 1.1 | 0.7 | 0.7 |
| Copper | 23950.0 | 10100.0 | 245.0 | 49.6 | 54.4 | 1820.0 |
| | 23950.0 | 8180.0 | 204.0 | 20.9 | 35.3 | 2140.0 |

(a) Interactions with the aqueous solution of contaminants and pipe segments were conducted for 24 hours at 20-25° C.
ND: non-detect.

TABLE 15
Aqueous Concentrations of Mercury in Various Steps^{(c)}

| | | | | | | |
|---|---|---|---|---|---|---|
| | Initial | 7-Day | | Rinse | | |
| Pipe | Conc. | Adherence | Extraction | #1 | Rinse #2 | Rinse #3 |
| Material | (mg/L) | (mg/L) | (mg/L) | (mg/L) | (mg/L) | (mg/L) |

Mercury #1

| | | | | | | |
|---|---|---|---|---|---|---|
| DIW | 7737.5 | 239.1 | 1294.2 | 441.1 | 0.4 | 0.4 |
| | 7737.5 | 0.2 | 2740.3 | 0.4 | 0.4 | 0.4 |
| PVC | 7737.5 | 7944.0 | 1.6 | 41.6 | 0.6 | 0.1 |
| | 7737.5 | 8238.0 | 2.6 | 60.9 | 0.9 | 0.2 |
| Copper | 7737.5 | 0.7 | 515.7 | 0.4 | 0.4 | 0.4 |
| | 7737.5 | 1.1 | 272.8 | 0.4 | 0.4 | 0.5 |

Mercury #2

| | | | | | | |
|---|---|---|---|---|---|---|
| DIW | 28800.0 | 20200.0 | 1520.0 | 230.0 | 22.2 | 9.5 |
| | 28800.0 | 20500.0 | 2290.0 | 413.0 | 46.0 | 12.3 |
| PVC | 28800.0 | 28900.0 | 0.3 | 204.0 | 2.3 | 0.5 |
| | 28800.0 | 32000.0 | 0.8 | 147.0 | 1.6 | 0.9 |
| Copper | 28800.0 | 5750.0 | 2930.0 | 166.0 | 40.8 | 77.6 |
| | 28800.0 | 4880.0 | 2800.0 | 906.0 | 114.0 | 99.0 |

Interaction with the aqueous solution of contaminants and pipe segments were conducted for 24 hours at 4-6° C.
Rinsing and extraction fluids used for various materials.
ND: non-detect.

Water rinse was done to remove the weakly-bound chemicals, while the strongly-bound chemicals, if any, were extracted with stronger solvents. The low concentration in the third rinsate indicates that three rinses were successful in removing the weakly-bound chemicals.

The initial aqueous concentration of mercury reduced significantly in ACI pipes (from 22,830 mg/L to 3.5-8.2 mg/L) and copper pipes (from 22,830 mg/L to about 41 mg/L). Very limited or no reduction in concentration was observed for PVC and DIE pipes. Significant amounts of mercury release from all the tested pipes, except HDPE and PVC, were observed when the extractant chemical decontaminant of the present disclosure was applied. There was limited or no adherence of mercury on HDPE and PVC pipes, which resulted in low concentration of mercury in the chemical decontaminant of the present disclosure.

### C. Effectiveness of Decontaminants

The aqueous concentrations of the contaminants at the beginning of the reaction with pipe (initial concentration, C_{w,0}), the concentration of remaining chemicals in the aqueous phase after reaction with pipe (final concentration, Cᵢ), the concentrations of chemicals recovered from the decontaminant and the subsequent first, second, and third rinses were listed in Table 16.

TABLE 16
Aqueous Concentrations of Mercury in Various Steps (Task 2)

| | | | | | | |
|---|---|---|---|---|---|---|
| | Initial | 7-Day | | | | |
| Pipe | Conc. | Adherence | Extraction | Rinse #1 | Rinse #2 | Rinse #3 |
| Material | (mg/L) | (mg/L) | (mg/L) | (mg/L) | (mg/L) | (mg/L) |

Extractant: Hypochlorite

| | | | | | | |
|---|---|---|---|---|---|---|
| DIW | 19530.00 | 1436.40 | 251.05 | 1221.00 | 5.02 | 1.61 |
| | 19530.00 | 4491.60 | 315.47 | 33.21 | 0.41 | 0.80 |
| PVC | 19530.00 | 19694.00 | 290.19 | 1912.00 | 0.41 | 0.37 |
| | 19530.00 | 20876.00 | 172.41 | 3.68 | 0.31 | 0.41 |
| COP | 19530.00 | 2.61 | 11.01 | 1.03 | 0.58 | 0.45 |
| | 19530.00 | 1.70 | 8.48 | 1.14 | 0.33 | 0.45 |
| DIE | 19530.00 | 21288.00 | 133.91 | 5.54 | 0.53 | 0.39 |
| | 19530.00 | 21653.00 | 136.16 | 7.28 | 1.63 | 0.83 |

Extractant: Simple Green ™

| | | | | | | |
|---|---|---|---|---|---|---|
| DIW | 19530.00 | 1461.04 | 83.30 | 23.99 | 6.86 | 4.05 |
| | 19530.00 | 6636.00 | 131.74 | 20.57 | 11.41 | 14.52 |
| PVC | 19530.00 | 19850.00 | 129.33 | 4.52 | 1.98 | 0.96 |
| | 19530.00 | 20343.00 | 215.68 | 3.48 | 0.24 | 0.17 |
| COP | 19530.00 | 2.08 | 0.53 | 2.41 | 0.50 | 0.52 |
| | 19530.00 | 1.84 | 0.83 | 1.90 | 0.36 | 0.46 |
| DIE | 19530.00 | 21626.00 | 303.88 | 11.77 | 1.11 | 0.70 |
| | 19530.00 | 21627.00 | 161.38 | 5.01 | 1.68 | 1.21 |

Extractant: Pipe Klean ™

| | | | | | | |
|---|---|---|---|---|---|---|
| DIW | 19530.00 | 10962.00 | 247.08 | 0.46 | 1.95 | 1.66 |
| | 19530.00 | 3772.00 | 82.08 | 0.39 | 1.14 | 1.11 |
| PVC | 19530.00 | 22578.00 | 180.64 | 1.72 | 0.20 | 0.12 |
| | 19530.00 | 22655.00 | 142.99 | 1.39 | 0.06 | 0.05 |
| COP | 19530.00 | 2.21 | 2.74 | 29.92 | 0.62 | 0.55 |
| | 19530.00 | 3.21 | 2.61 | 5.13 | 0.51 | 0.50 |
| DIE | 19530.00 | 21971.00 | 212.13 | 7.78 | 1.08 | 0.55 |
| | 19530.00 | 22035.00 | 107.78 | 4.72 | 0.72 | 0.53 |

(a) Interactions with the aqueous solution of contaminants and pipe segments were conducted for 7 days at 20-25° C.
Aqueous solutions of decontaminant agents were used as extractants.

Though mercury adhered on DIW and copper pipes, the three commercially available decontaminants were not effective in releasing the adhered mercury. The release of mercury from DIW pipes by hypochlorite were 251 mg/L and 315 mg/L; by Simple Green® were 83 mg/L and 132 mg/L; and by Pipe Klean® were 82 mg/L and 247 mg/L (input concentration of mercury=19530 mg/L). The release of mercury from copper pipes by hypochlorite were 8.5 mg/L and 11 mg/L; by Simple Green® were 0.5 mg/L and 0.8 mg/L; and by Pipe Klean® were 2.6 mg/L and 2.7 mg/L (input concentration of Hg=19530 mg/L). It is important to note that when the chemical decontaminant of the present disclosure was used as extractant (Task 1A), it was able to recover more mercury than the three commercially available decontaminants. The release of mercury by the chemical decontaminant of the present disclosure from DIW pipes were 3611 mg/L and 1265 mg/L and from copper pipes were 7368 mg/L and 6414 mg/L. The initial concentration of mercury for Task 1A was 22829.8 mg/L.

### D. Effect of Exposure Duration and Temperature

The effect of exposure duration on adherence of selected chemicals was studied by conducting the adherence tests for 24 hours and 7 days. As indicated before, a larger list of chemical-infrastructural material combinations were tested for 7 days and a shorter list of combinations were selected for the shorter exposure time. The shorter time interval was selected as it is useful to know if adhesion of contaminants can be prevented by removing the contaminated water within a shorter period of time.

The effect of temperature on surface adherence of the selected contaminants was studied by conducting the tests at about 4 to 6° C. (a typical winter temperature) and at room temperature (20-25° C.).

Schwarzenbach et al. (1993) stated that the temperature effect of sorption is mainly caused by the temperature effect on solubility. Together with the increased volatilization rate at higher temperatures, increased temperatures generally lead to higher solubility and thus lower sorption coefficients (Lüers and ten Hulscher, 1996). Since adsorption is an exothermic process, values of sorption coefficient usually decrease with increasing temperature. A 10% decrease in sorption coefficient would occur with a temperature rise from 20 to 30° C. (Bennett, 2006). However, as per Arrhenius principle, if the contaminants are undergoing reaction on the pipe surface, the rate of a reaction doubles with every 10° C. rise in temperature (Dungan et al., 2001). Due to these complex factors, mechanism of adhesion of individual contaminants on various types of surfaces plays an important role. Increase in exposure time is expected to increase the adhesion for the contaminants, which are stable under the environmental condition within that period of time.

The adhesion coefficients have been used here as a parameter to evaluate adherence under various conditions. The average adhesion coefficients of mercury on DIW, PVC and copper are shown in Table 17 below.

TABLE 17
Adhesion Coefficients of
Selected Mercury-Infrastructural Material Combinations

| Contaminants | Adhesion coefficient (L/m²) | | |
|---|---|---|---|
| and Pipes | 7-days, 20-25° C. | 24 hours, 20-25° C. | 7-days, 4-6° C. |
| DIW | 3.18 | 5.41 | 5.62 |
| PVC | NA | NA | NA |
| Copper | 6.61 | 4.15 | 5.45 |

The adhesion coefficient of mercury in DIW at 7 days and room temperature was estimated to be 3.18 L/m², which was less than that at 24 hours or low temperature conditions. However, under Task 2 (before application of decontaminants) the adhesion coefficients of adhered mercury varied from 10.4 to 13.9 L/m². The adhesion coefficient of mercury on copper at 7 days and room temperature condition was higher than the other two conditions. Adhesion coefficients of fluoroacetate were generally higher under 7 days and room temperature condition than those at 24 hours or low temperature conditions. Similar behavior was observed for strychnine and mevinphos, except for strychnine in DIW pipe. Though no significant change in adherence was observed with increase in reaction time or temperature within the test conditions studied, generally, more adhesion was observed at room temperature with longer exposure time than shorter exposure time or lower temperature.

As expected, these results were fairly variable due to a number of factors, including chemical contaminants, various types of material of construction, shape and size of pipe segments, and application of various types of decontaminants. For example, corrosion products on the inner wall of ACI pipes varied during various steps of adherence and extraction steps. Iron oxides and hydroxides have profound affinity towards various chemicals and these loosely bound corrosion products caused differing levels particulate matter present in pipe segments. The pipe surface could have released chemicals that might influence the contaminant and/or the decontaminant. For example, calcium (Ca) possibly leached from the cement lining of ductile iron pipes, which caused an increase in pH of the equilibrated water. The increase in pH can cause hydrolysis of contaminants. The presence of Ca ions can also form complex or precipitate with the contaminants.

Most of the reaction occurred while the pipe segments were enclosed by the leak-proof seals. Though care was taken to minimize the exposure time, the evaporation during the opening and closing of the reactors could have contributed to some losses. These tests did not consider any losses due to biodegradation, pH changes, degradation products or other compounds co-eluting with analytes. The experimental controls were sufficient to preclude these processes from having a significant effect on the experimental observations.

The adherences of mercury on various pipes were significant. It showed significantly high amount of adherence on copper pipes (adhesion coefficient=6.61 L/m² for 7-days at 20-25° C.). To understand the nature and type of adherence, mercury on copper, was selected for spectroscopic analyses. This section discusses the spectroscopic results obtained.

### X-Ray Diffraction

The x-ray pattern of copper pipe treated with mercury can be indexed to two different materials. The most abundant phase is paratacamite (Cu₂Cl[OH]₃). The other major component is calomel, (Hg₂Cl₂). There were several very small peaks found but they were not indexed.

An attempt was made to quantify the abundances of the two identified phases. The MDI Jade software contains an option for whole pattern fitting (WPF) of the collected data and Rietveld refinement of present crystal structures. One fits a diffraction model to the measured pattern by non-linear least squares optimization in which certain parameters are varied to improve the fit of the model to the observed data. Modeling parameters include background, profile parameters, and lattice constants. Typically, the crystal structures of the phases of interest must be known along with atomic coordinates, occupancies and thermal parameters. A two-phase whole pattern fitting control file was created with entries for paratacamite and calomel. The generalized control file was used to perform a least squares iteration of various refinable parameters in order to minimize the differences between the observed and the simulated patterns. After an initial refinement, each individual phase was checked against the refinement and adjusted (parameters to make it fit the observed pattern better). A second refinement was performed. A successful refinement is defined mathematically by the convergence of refinable parameters to meaningful values. The refined pattern was checked against the observed data and the weight fractions of the individual phases are displayed. The total weight fractions were forced to sum to 100% and are rounded to the nearest integer. The data uncertainties are believed to be approximately +/−5%. The quantitative results obtained showed 80% paratacamite and 20% calomel.

In drinking water, the primary oxidizer agents are dissolved oxygen and free chlorine species. Following the oxidation, dissolved cuprous or cupric ions form complexes with aqueous anion ligands and other solid phases such as copper hydroxy chloride (atacamite, Cu₄(OH)₆Cl₂ or paratacamite, Cu₂Cl[OH]₃). Overall reactions pathway of electrons follow the outer-sphere mechanisms (Stumm and Morgan, 1996).

Cu_{(M)}⁰+½O_{2(aq)} [symbol] Cu²⁺+2OH⁻log K=33.82

Cu²⁺+Cu_{(M)}⁰+2OH⁻ [symbol] Cu₂O₍ₛ₎+H₂O log K=23.50

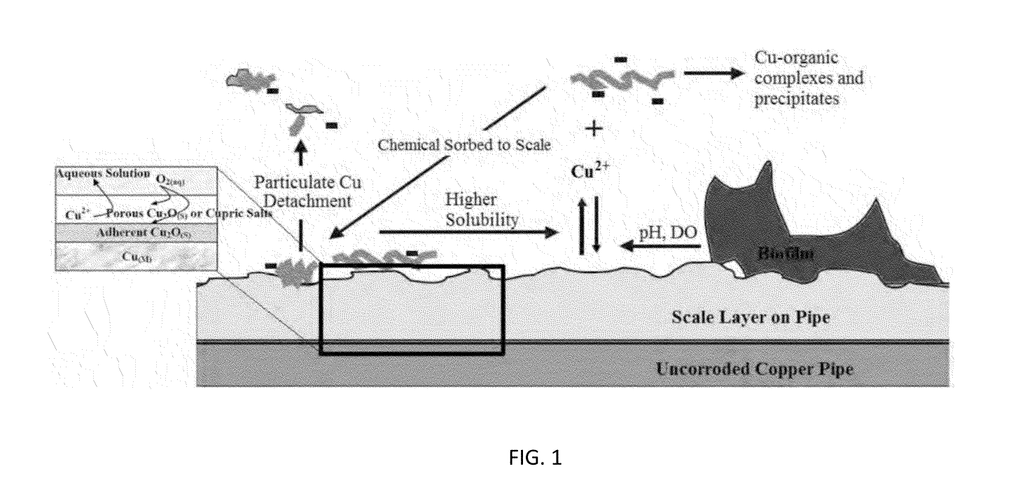

Between these two cuprite formation pathways, the first reaction happens very quickly on copper surfaces, which results in a compact scale layer. With the formation of cuprite layer proceeding, oxygen is reduced at the exterior of the adherent layer, therefore further oxidation produces a porous layer, not so compact as the underlying curpite layer. Further oxidation of cuprite to cupric species and subsequent cupric precipitation may occur and dominate the outer layer reactions until the equilibrium is achieved. An illustration of scale layers and their distribution are presented in FIG. 1.

### Scanning Electron Microscopy (SEM)/Energy Dispersive Spectrometer (EDS)

The interior surface of the cut pipe was examined under a binocular microscope. Several different phases were seen. At least four different colored materials (blue-green, yellow-green, brown and silver spherules) were visible.

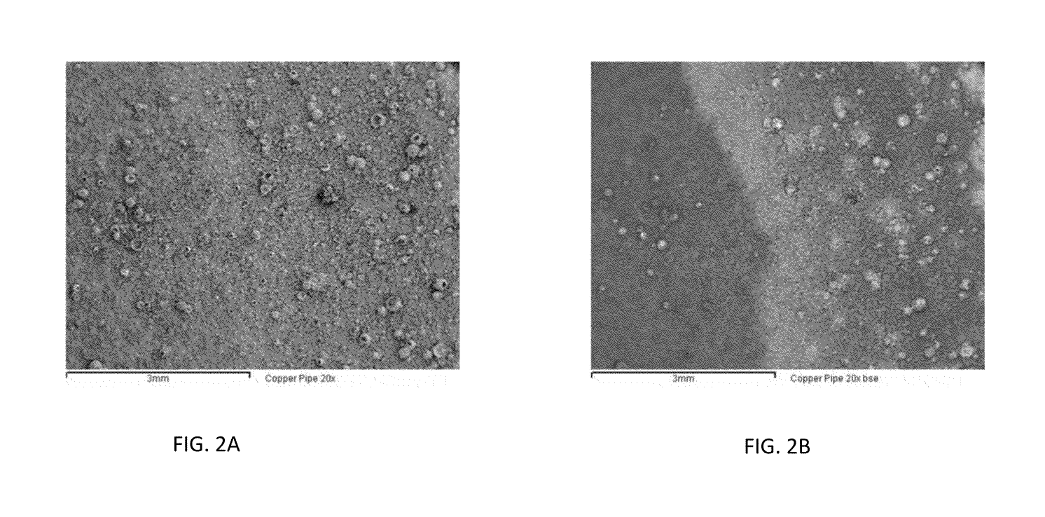

The cut pipe sample was then carbon coated to examine in the JEOL 840A SEM. An accelerating voltage of 15 kV was used and both secondary and backscattered electron images at several magnifications were collected. FIG. 2A, imaged at 20 times magnification, shows a field of view for secondary electrons and FIG. 2B shows the same field of view for backscattered electrons of a representative region of adhered mercury on copper pipe sample.

The backscattered image (FIG. 2B) shows compositional differences and corresponds to a region on FIG. 2B. The Oxford INCA 300 Energy Dispersive Spectrometer (attached to SEM) was then employed to attempt to understand the chemistry of the different areas. X-rays were collected for 30 seconds live time in spot mode. The EDS data were normalized to 100%. The result indicates information on presence of specific elements and their approximate abundances. The blue-green regions were examined first. These areas are primarily composed of copper chloride hydroxide with little mercury present.

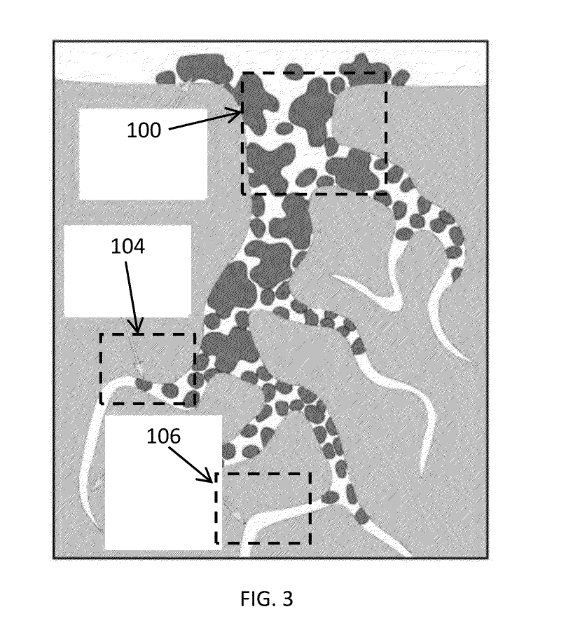

The entrapment of contaminants present in water on the porous surface is illustrated in FIG. 3. FIG. 3 shows a first region 100 where pore volume is available to sorbate (contaminant) 102 and solvent (water or decontaminant). A second region 104 shows an area where pore volume is available to solvent and smaller sorbate 102 particles. A third region 106 shows an area where pore volume will only allow for the presence of solvent. The pore size is too small in the third region for sorbate. It appears that some of the contaminants may be trapped and may not leach immediately upon application of the decontaminant, as the pore size may be too small to be accessible to the solvent.

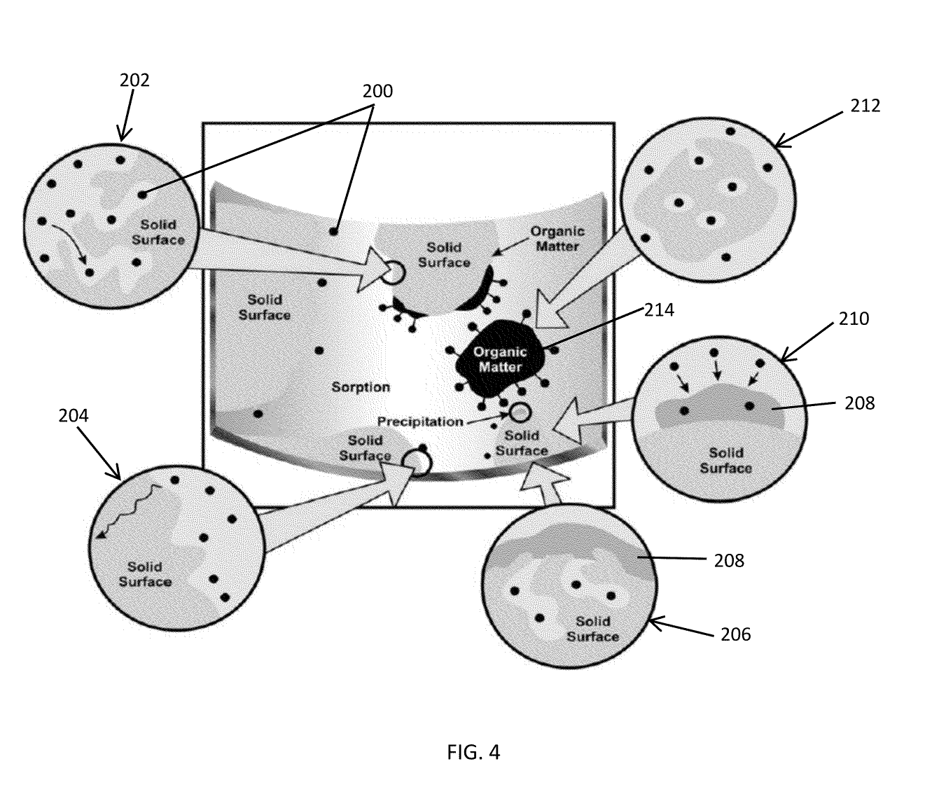

FIG. 4 shows occlusion of contaminant particles within organic matter and other surfaces in an infrastructural system. Chemical contaminant 200 is represented by black dots. A first region 202 is highlighted showing surface pore diffusion into a solid surface. A second region 204 shows a representation of solid state diffusion. A third region 206 that is highlighted shows occlusion of contaminant 200 through precipitation of a new metal solid phase 208. A fourth region 210 that is highlighted shows precipitation the new metal solid phase 208. A fifth region 212 that is highlighted shows occlusion of contaminant 200 in organic matter 214.

The following conclusions may be drawn from the data of the above study:
the chemical decontaminant of the present disclosure can effectively remove mercury and organophosphates from all the solid surfaces more effectively than any other decontaminant tested.
Metals surfaces exposed to aqueous solution will corrode to form some kind of layer at the surface. The properties and composition of the layer is dependent on the metal and the water chemistry. Thus a three layered structure will result, metal/film/solution, and the continuation of the corrosion process will be dependent on the processes at the metal/film and film/solution interfaces. Also the properties of the film can be important for the adherence process. The surface complexation model may highlight on the processes at the film/solution interface.
Copper pipe adhered significant amount of mercury onto its wetted surface area. The presence of organic matter can reverse copper corrosion by-product release. In the presence of oxygen, copper metal corrodes forming a solid scale layer of Cu(OH)₂ (malachite). Copper can react with organic matter/biofilm forming either soluble complexes, particulate complexes, or precipitates depending on the nature of the ligands involved. These types of reactions tend to release corrosion by-product release. However, the presence of chloride or other catalysts can also cause re-deposition of previously released material onto an inner surface wall.
The removal of adhered contaminants by decontaminants, hypochlorite, Simple Green® and Pipe Klean®, appears to be contaminant specific and specific to the type of surface on which the chemicals are applied. As indicated in this study, some of the extractant solvents (like hot water, the chemical decontaminant of the present disclosure) can be used selectively on specific contaminants. However, the removal of contaminants using hypochlorite, Simple Green®, Pipe Klean® or hot water were significantly less than the removal results achieved using the decontaminant disclosed herein.
Rinsing results of the adhered contaminants indicate that the water flushing can be used to rid the distribution system of stagnant, contaminated water, but water flushing alone did not remove most of the chemical contaminants that are complexed onto the pipe surface or entrapped in the micropores. As such, a decontaminating agent such as the one disclosed herein is necessary to remove chemical contaminants.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A decontaminant composition comprising: from about 3% to about 5%, by weight, of a permanganate compound; from about 8% to about 12%, by weight, of a strong mineral acid; and from about 80% to about 90%, by weight, of a solvent.

2. The decontaminant composition of claim 1 further comprising from about 0.5% to about 3%, by weight, of a persulfate compound.

3. The decontaminant composition of claim 1 further comprising from about 100 parts per million to about 10,000 parts per million of a surfactant.

4. The decontaminant composition of claim 1 wherein the solvent consists essentially of water.

5. The decontaminant composition of claim 2 comprising about 1%, by weight, of a persulfate compound.

6. The decontaminant composition of claim 1 comprising about 4%, by weight, of a permanganate compound.

7. The decontaminant composition of claim 1 comprising about 10%, by weight, of a strong mineral acid.

8. The decontaminant composition of claim 7 wherein the strong mineral acid consists essentially of sulfuric acid.

9. The decontaminant composition of claim 7 wherein the strong mineral acid is selected from the group consisting of perchloric acid, hydroiodic acid, hydrobromic acid, hydrochloric acid, sulfuric acid and combinations thereof.

10. The decontaminant composition of claim 6 wherein the permanganate compound is selected from the group consisting of sodium permanganate and potassium permanganate.

11. The decontaminant composition of claim 5 wherein the persulfate compound consists essentially of sodium persulfate.

12. The decontaminant composition of claim 3 comprising about 0.8%, by weight, of surfactant.

13. A decontaminant composition comprising from about 0.5% to about 2%, by weight, of sodium persulfate; from about 100 parts per million to about 10,000 parts per million of a surfactant; from about 3% to about 5%, by weight, of a compound selected from the group consisting of sodium permanganate, potassium permanganate or combinations thereof; from about 8% to about 12%, by weight, of a strong mineral acid selected from the group consisting of perchloric acid, hydroiodic acid, hydrobromic acid, hydrochloric acid, sulfuric acid and combinations thereof; and from about 80% to about 88%, by weight, of water.

14. A method of decontaminating an infrastructural system comprising the step of exposing a surface of the infrastructural system with a chemical compound comprising from about 3% to about 5%, by weight, of a permanganate compound; from about 8% to about 12%, by weight, of a strong mineral acid; and from about 80% to about 90%, by weight, of a solvent.

15. The method of claim 14 wherein the exposing step further comprises exposing a surface of the infrastructural system with a chemical compound comprising from about 3% to about 5%, by weight, of a permanganate compound; from about 8% to about 12%, by weight, of a strong mineral acid; from about 100 parts per million to about 10,000 parts per million of a surfactant; and from about 80% to about 90%, by weight, of a solvent.

16. The method of claim 14 wherein the exposing step further comprises exposing a surface of the infrastructural system with a chemical compound comprising from about 3% to about 5%, by weight, of a permanganate compound; from about 8% to about 12%, by weight, of a strong mineral acid; from about 0.5% to about 3%, by weight, of a persulfate compound; and from about 80% to about 90%, by weight, of a solvent.

17. The method of claim 14 wherein the exposing step further comprises exposing a surface of the infrastructural system with a chemical compound comprising from about 0.5% to about 2%, by weight, of sodium persulfate; from about 100 parts per million to about 10,000 parts per million of a surfactant; from about 3% to about 5%, by weight, of a compound selected from the group consisting of sodium permanganate and potassium permanganate; from about 8% to about 12%, by weight, of a strong mineral acid selected from the group consisting of perchloric acid, hydroiodic acid, hydrobromic acid, hydrochloric acid, sulfuric acid and combinations thereof; and from about 80% to about 88%, by weight, of water.

18. The method of claim 15 wherein the exposing step further comprises exposing a surface of the infrastructural system with a chemical compound comprising about 4%, by weight, of a permanganate compound; about 10%, by weight, of a strong mineral acid; from about 100 parts per million to about 10,000 parts per million of a surfactant; and from about 80% to about 86%, by weight, of a solvent.

19. The method of claim 16 wherein the exposing step further comprises exposing a surface of the infrastructural system with a chemical compound comprising about 4%, by weight, of a permanganate compound; about 10%, by weight, of a strong mineral acid; about 1%, by weight, of a persulfate compound; and from about 80% to about 86%, by weight, of a solvent.

20. The method of claim 14 wherein the exposing step further comprises an action selected from the group consisting of pouring the chemical compound on a contaminated surface, wiping a contaminated surface with the chemical compound using a cloth-like material, immersing a contaminated infrastructural body inside a vessel containing the chemical compound, and recirculating the chemical compound inside a fluid transport body.
